(19) United States
(12) Patent Application Publication
(10) Pub. No.: US 2019/0113413 A1
(43) Pub. Date: Apr. 18, 2019

(54) METHOD FOR ACQUIRING AMOUNT OF UNBALANCE OF ROTOR

(71) Applicants: Weijian GUO, (US); Fang JIANG, (US)

(72) Inventors: Weijian GUO, Beijing (CN); Fang JIANG, Beijing (CN)

(21) Appl. No.: 16/087,569

(22) PCT Filed: Mar. 15, 2017
(86) PCT No.: PCT/CN2017/076803

§ 371 Date: Sep. 21, 2018

(30) Foreign Application Priority Data
Mar. 22, 2016 (CN) 201610166620.1

(51) Int. Cl. G01M 1/16

(52) U.S. Cl. CPC G01M 1/16; H02K 15/165

(57) ABSTRACT

This invention provides a method for acquiring the unbalance of a rotor. It is used for decoupling the unbalance of the rotor and the unbalance of the balancing machine itself, including below procedures: set at least two reference points of the unbalance on the rotor, on the plane perpendicular to the rotating axis of the rotor, there is an angle between the lines connecting the projection of each reference point to the projection of the rotating axis; measure the unbalance of the rotor in sequence by using each reference point as angle reference; through vector calculation of the unbalance corresponding to two arbitrarily selected reference points, the unbalance of the rotor is obtained. By setting at least two zero angle reference points of the unbalance on the rotor before the measurement can avoid the influence to the unbalance of the rotor caused by the change of zero angle reference point during the measurement process.

### TECHNICAL FIELD OF THE INVENTION

This invention is related to a method to acquire the unbalance of a rotor.

### DESCRIPTION OF THE PRIOR ART

Drive types for unbalance measurement of a rotor on balancing machine is mainly divided into belt drive and end drive.

With belt drive type, a rotor is driven via the belt, no rigid mechanical part of drive unit contacts the rotor and rotates with the rotor in the same speed. At the practical balancing process, using support rollers to drive the rotor to rotate, using air to drive the rotor to rotate and so on, has the same effect with the belt drive. This invention is applicable for this drive type which is briefly called “free angle drive type” in the below description.

With end drive type, the rotor is driven to rotate by drive device through drive shaft and other connecting parts. In this type, there is rigid mechanical part contacts with the rotor and rotates with the measured rotor in the same speed.

The unbalance acquired on balancing machine with belt drive type (free angle drive type) or end drive type is a vector sum of the unbalance of a rotor and a balancing machine itself. It is necessary to invent a method for decoupling the unbalance of the rotor and the unbalance of the balancing machine itself, to obtain the unbalance of the rotor.

This invention is related to the method for the unbalance measuring of the rotor with free angle drive type. For example, with the belt drive, direction (or angle) of the unbalance of the rotor has direct relation with the change of zero-angle reference point on the rotor, while direction and amount of the unbalance of any other mechanical parts, drive unit, and measuring unit itself of balancing machine has no relation with the change of zero angle reference point on the rotor; by the method of setting different zero angle reference point, measure the unbalance of the rotor respectively, then the unbalance of the rotor itself is acquired through vector calculation.

In prior technology for acquiring the unbalance of the rotor, when setting a different zero angle reference point, the rotor is rotated for a certain angle relative to balancing machine, zero angle reference point is shifted with same angle in reverse direction of the rotor rotating. The problem of this technology is that, the procedure is complicated because the rotor is rotated relative to balancing machine for changing zero-angle reference point on the rotor. Additionally, the material being used as reference point always has a certain mass, hence the unbalance of the rotor is influenced when reference point being changed; The reference point is changed between different measuring processes at measuring site, it is not easy to make accurate angle and not convenient to make the change.

### CONTENT OF INVENTION

In view of the above technical problem, the purpose of this invention is to provide a method to acquire the unbalance of a rotor without the necessity of rotating the rotor for a certain angle relative to balancing machine. And the purpose of this invention is also to provide a method to acquire the unbalance of a rotor to avoid the influence caused by the change of zero angle reference point to the unbalance of the rotor.

In implementation 1 of this invention, the method for acquiring the unbalance of a rotor is used for decoupling the unbalance of the rotor and the unbalance of balancing machine itself, setting a zero angle reference point of the unbalance on the rotor and using this reference point as angle reference to measure the unbalance of the rotor.

Remove zero angle reference point of the unbalance, remake a new zero reference point in a different angle position from the above mentioned zero angle reference point, then measure the unbalance of the rotor. This procedure should be made at least once.

By vector calculation of the unbalances corresponding to any of two selected reference points, the unbalance of the rotor is obtained.

Through the above-mentioned implementation, it is not necessary to rotate the rotor for a certain angle relative to the balancing machine, the procedure is simple for changing zero angle reference point directly on the rotor to obtain the unbalance of the rotor.

In Implementation 2 of this invention, set at least two zero angle reference points of the unbalance on the rotor, on the plane perpendicular to the rotating axis of the rotor, there is an angle between the lines connecting the projection of each reference point to the projection of the rotating axis; measure the unbalance of the rotor in sequence with each reference point as the angle reference; through the vector calculation of the unbalance corresponding to any of two selected reference points, the unbalance of the rotor is obtained.

Making at least two zero angle reference points of the unbalance on a rotor before the measurement avoids that the unbalance of the rotor is influenced by the change of zero angle reference point during the measuring process.

This implementation is especially suitable for manufacturing unbalance standard rotor.

Implementation 3 is based on Implementation 2, use two reference points. In this way, by the vector calculation of unbalances with the two points, it is easy and convenient to obtain the unbalance of the rotor.

Implementation 4 provides a method to obtain the unbalance of the rotor, setting zero angle reference points in the same plane which is perpendicular to the rotating axis, and in this plane, the distance between the points and the rotating axis is different.

Thus, zero angle reference point can be set, for example in the same end plane of the rotor, for easy observation.

In Implementation 5, set zero angle reference point of the unbalance on different plane perpendicular to the rotating axis.

Thus, it is suitable for a rotor on which it is more convenient to set reference point in axial direction.

Implementation 6 provides a rotor, with at least two zero angle reference points being set on the rotor in the plane perpendicular to the rotating axis, there is an angle between the lines connecting the projection of each reference point to the projection of the rotating axis.

With this rotor, by setting at least two zero angle reference points of the unbalance on the rotor before measurement can avoid unbalance influence to the rotor caused by the change of zero angle reference point during the measurement.

Implementation 7 gives a rotor, based on Implementation 6, zero angle reference point of the unbalance is set on the same plane perpendicular to the rotating axis, in this plane, the distance between each reference point and the rotating axis is different.

For such a rotor, zero angle reference point can be set, for example, in the same end plane for easy observation of zero angle reference point.

Implementation 8 provides a rotor, based on Implementation 6, zero angle reference point of the unbalance is set on different plane perpendicular to the rotating axis.

In this way, it is suitable for a rotor on which setting reference point in axial direction is more convenient.

### BRIEF DESCRIPTION OF THE DRAWINGS

FIG. 1 shows a rotor R, (a) is main view of the rotor, (b) is side view of the rotor.

FIG. 2 shows first nominal unbalance of a rotor R, (a) is plane PL1, (b) is plane PL2.

FIG. 3 is the schematic drawing for illustrating zero angle reference point being shifted to 180 degree position, (a) is main view of the rotor, (b) is side view of the rotor.

FIG. 4 shows second nominal unbalance of a rotor R, and schematic drawing of vector calculation, (a) is plane PL1, (b) is plane PL2.

FIG. 5 is the schematic drawing for setting two zero angle reference points on end plane of a rotor, (a) is main view of the rotor, (b) is side view of the rotor.

FIG. 6 is the schematic drawing for setting two zero angle reference points in rotor length direction, (a) is main view of the rotor, (b) is side view of the rotor.

FIG. 7 is the schematic drawing for setting two zero angle reference points on a four-cylinder crankshaft.

### DESCRIPTION OF A SAMPLE IMPLEMENTATION

A sample implementation of this invention is prescribed in this section with the help of the illustrations. For easier explanation, the implementation procedures are basically in the order of the realization of this invention, but some sections are not necessarily sequential, and the prescribed procedure is not unique. The procedure is for illustrative purpose, not all the steps are necessary, as long as that the invention can be realized. The method and procedure prescribed in this section do not in any way limit the protection area of this invention.

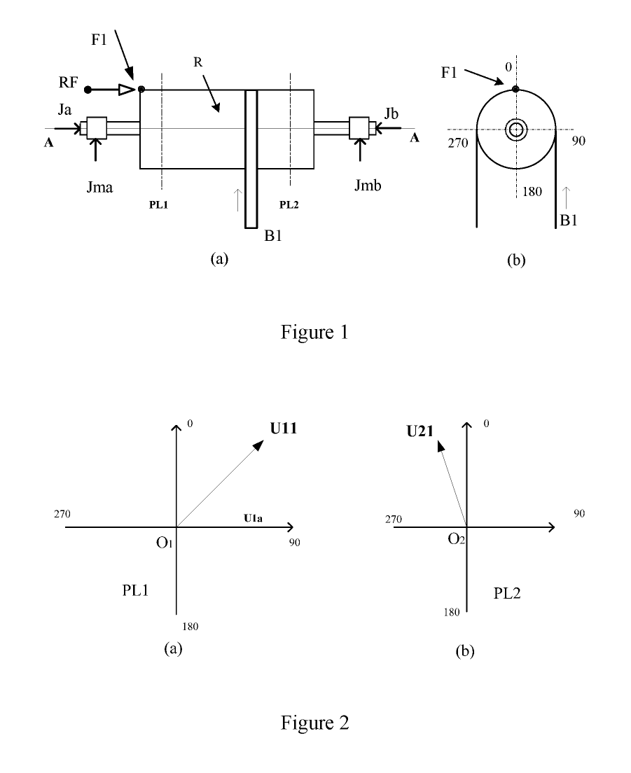

A. FIG. 1 shows a rotor R. In FIG. 1, (a) is main view of the rotor, (b) is side view of the rotor, that is, end plane of the rotor. Mark angle index, such as 0 degree, 90 degree, 180 degree, 270 degree, on two end planes of the rotor. When mass distribution of the rotor R, namely mass axis is not in the line with the rotating axis A-A of the rotor, the rotor R has the unbalance. The rotor mentioned in this invention is rigid rotor, that is, its mass and its mass distribution is regards as constant, and its unbalance does not change with the different speed of the rotor during the balancing measurement. An unbalance is a vector including amount and direction (or called angle). It is necessary to set zero angle reference point as the angle reference on the rotor, then use this point as the starting point of the direction or angle of the rotor unbalance. When the angle of reference point is made differently, the angle of the rotor unbalance changes accordingly. Unbalance of a rotor R can be represented by two unbalances in two arbitrarily selected planes perpendicular to rotating axis, as plane PL1 and plane PL2 shown in FIG. 1. For some rotors if the length compared with its diameter is small, the unbalance can be represented by one plane.

In this invention, for the illustration, an example that a rotor being supported horizontally on balancing machine is used. Left and right rotating journals of the rotor supported by the supporting part Jma and Jmb on balancing machine form a rotating axis A-A of the rotor. The supporting parts on balancing machine for the rotor include the rollers, the bearing sleeve and V-blocks, etc.

Axial stop part is placed for the rotor on the balancing machine, as shown as Ja and Jb of FIG. 1. Axial stop part should act on the smooth surface of the rotor and be close to rotating axis of the rotor as much as possible, so as that the unbalance caused by axial stop part to the rotor can be neglected.

Balancing machine needs to drive the rotor and accelerate it up to the measuring speed to realize unbalance measurement.

Two types that a balancing machine drives a rotor are belt drive (free angle drive) and end drive. This invention is only specific to free angle drive type.

FIG. 1 is the schematic drawing for drive belt, B1 is belt. The characteristics of the belt drive is that no rigid mechanical parts of drive unit contact with the measured rotor and rotate with the measured rotor in same speed, unbalance of mechanical parts and unbalance of drive unit is not superimposing with unbalance of rotor, that is, in belt drive type, only the direction (or angle) of the rotor unbalance has relation with the change of zero angle reference point on the rotor, while the amount and the direction of the unbalance of the measuring system in balancing machine and mechanical parts except the rotor has no relation with the change of zero angle reference point. As long as drive types fulfill the above characteristics, they can be regarded as belt drive type. Supporting roller drive, air drive etc., which comply with the above characteristics can be regarded as belt drive. In this invention, the above mentioned drive type is generally designated as “Free angle drive type”.

In practical application, free angle drive also has vertical setup, for example, air bearing balancing machine with vertical structure for turbocharger compressor wheels. Rotor is placed vertically, and floated by compressed air, additional air nozzle with compressed air drive the rotor rotating. Thus, the implementation of this invention is not limited to the rotor being placed horizontally.

Different with free angle drive type, drive mechanism of end drive unit drives the rotor by drive shaft, drive pin etc., which are mechanically parts, and rotates with the rotor in same speed, thus the unbalances of the drive unit and the drive shaft etc. of mechanical connecting parts are superimposing with the rotor. If change zero angle reference point of the unbalance on the rotor, the direction of the unbalance of these mechanical parts will change accordingly. For end drive, it is more accurate to be called as “fixed angle drive”.

For nearly all vertical balancing machines, the rotor to be balanced is positioned and clamped on the balancing machine by fixture of balancing machine, the fixture etc. mechanical parts rotate with the rotor in same speed, this balancing drive type is regarded as end drive.

B. For “free angle drive type”, this invention provides the methods to obtain the unbalance of the rotor by changing zero angle reference point.

Set zero angle reference point on the rotor, as shown as F1 in (a) and (b) in FIG. 1. There are many methods to set reference point on the rotor, for example, using color pen to paint a mark, adhere a reflective tape etc. The mass of the marked reference point should be as small as possible, to reduce the influence caused by the mass of the reference point to the unbalance of the rotor when changing the reference point.

Angle sensor is placed on the balancing machine, as shown as RF in (a) FIG. 1. Angle sensor detects zero angle reference point to obtain the direction of the unbalance of the rotor, that is, the angle of the unbalance relative to zero angle reference point.

When rotating axis of the rotor is fixed, measuring plane is selected and zero angle reference point is selected, the amount and the direction (angle) of the unbalance of a rotor is unique.

Using the balancing machine as shown in FIG. 1 to measure the unbalance of a rotor. During the unbalance measurement, measurement can be repeated many times in each step for rotor R, then take the average value of multiple measurements as the measured value of the unbalance. The measured unbalance is represented by unbalance U11 (first nominal unbalance, including amount and direction) in the first plane PL1 and unbalance U21 (first nominal unbalance, including amount and direction) in the second plane PL2. Plot the first nominal unbalance into the plane coordinates. The origin of the coordinates is zero amount of the measured unbalance, 0 degree of the coordinate is zero angle reference point on the rotor, as shown in FIG. 2. The measured first nominal unbalance U11 and U21 is the vector sum of the unbalance of the balancing machine itself and the unbalance of the rotor. The unbalance of the balancing machine includes the unbalance of other mechanical parts except the rotor and the unbalance of the measuring system.

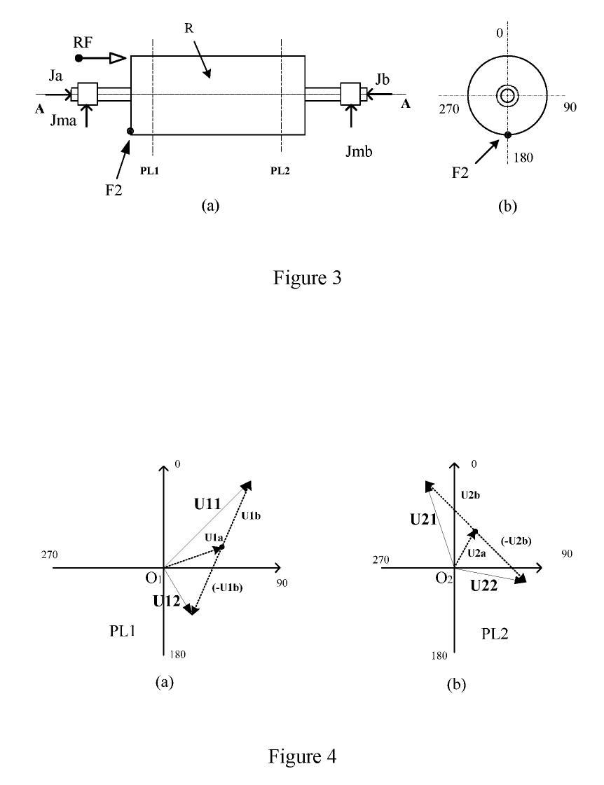

C. To separate the unbalance of the rotor itself, change zero angle reference point on the rotor, that is, remove zero angle reference point and make a new reference point at a new angle position. There is no special limitation for the changed angle of the reference point, in this implementation, reference point of the rotor is changed for 180 degree, that is, remove the original zero angle reference point F1 and make a new reference point F2 at 180 degree of the rotor, as shown in FIG. 3.

Measure the unbalance of rotor R again. The measured unbalance is represented by the measured unbalance U12 (second nominal unbalance, including amount and direction) in the first plane PL1 and the measured unbalance U22 (second nominal unbalance, including amount and direction) in the second plane PL2. Plot the second nominal unbalance into the plane coordinates, as shown in FIG. 4.

During two measurements, the amount and the direction of the unbalance of the balancing machine keep unchanged; the amount of the unbalance of the rotor R has no change, but the direction of the unbalance is changed with 180 degree because zero angle reference point is changed for 180 degree, as shown in FIG. 4. According to vector calculation, the unbalance U1b of rotor R in the first plane PL1 and the unbalance U2b of the rotor R in the second plane PL2 is obtained, and the unbalance −U1b and −U2b respectively in the two planes after zero-angle reference point being reversed with 180 degree are obtained. U1a and U2a in FIG. 4 is the unbalance of the balancing machine itself except the rotor in measuring plane PL1 and PL2.

D. According to the measured unbalance and the calculated unbalance of the rotor R, make correction to the rotor so that the unbalance of the rotor is less than a setting value.

E. When change zero angle reference point on rotor R as per the above procedure C, reference point always has a certain mass, the unbalance of the rotor is influenced by changing the reference point. Additionally, in the middle of the measuring process, changing reference point is neither precise nor convenient. Thus, the invention further takes below optimal method to set zero angle reference point of the unbalance, to eliminate the influence caused by the mass of reference point to the unbalance of the rotor.

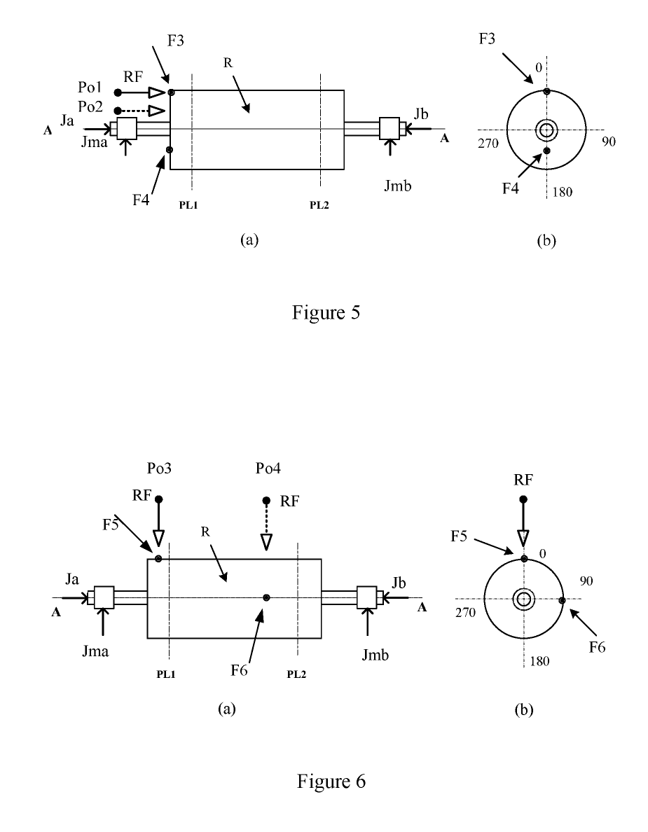

As shown in FIG. 5, make two reference points F3 and F4 in one end plane of rotor R. In this implementation, an example for the illustration is that two reference points deviates 180 degree, F3 locates at the radius position, F4 locates at the half radius position.

Place rotor R onto the balancing machine and set angle sensor RF on the position Po1. In this position, the sensor RF can only detect zero angle reference point F3. Measure the unbalance of the rotor R which is recorded as the first nominal unbalance.

Adjust the angle sensor RF to the position Po2 on the balancing machine, in this position, the sensor RF can only detect zero angle reference point F4. Measure the unbalance of the rotor R which is recorded as the second nominal unbalance.

During two measurements, the amount and the direction of the unbalance of the balancing machine itself keep unchanged; the amount of the unbalance of the rotor R has no change, but its direction is changed for 180 degree. As per the unbalance measured in two measurements and through vector calculation, the unbalance of the rotor is obtained.

There is no special requirement for the setting position of the above mentioned two zero angle reference points, as long as F3 and F4 deviates for a certain degree and the angle sensor RF can only detect one reference point at each position. Optimal selection is that the position of two zero angle reference point is different in radius direction.

More zero angle reference points can be set on the rotor, every two points should deviate for a certain degree and the angle sensor RF should only detect one reference point at each position. Optimal selection is that every two reference points deviate for a certain distance in radius direction.

When move angle sensor from one position to a new position to detect a new zero angle reference point, the position of the angle sensor should be set up so that the angle between two perpendicular lines as following is zero when view the two lines along the rotational axis, the two perpendicular lines are, the perpendicular line drawn from the point where the space position of new zero angle reference point is being detected by the angle sensor to the rotating axis of the rotor, and the perpendicular line drawn from the point where the space position of previous zero angle reference point is being detected by the angle sensor to the rotating axis of the rotor. A simple method is that move the angle sensor along a fixed radial direction of the end plane of the rotor, as shown in FIG. 5.

Select two reference points arbitrarily and use balancing machine to measure the unbalance of the rotor respectively, through vector calculation, the unbalance of the rotor is obtained.

Two reference points can be selected a combination in sequence, in each combination, at least one reference point should be different with other combination, through multiple measurement and calculation, multiple unbalance of the rotor is obtained and then take the average value as the final unbalance of the rotor.

Make multiple zero angle reference points on the test rotor which being used for the calibration of the balancing machine, in this way, not only it is assured the test rotor has the accurate unbalance, but also it is convenient for the operator to check the unbalance of the test rotor.

F. FIG. 6 shows another method to set multiple zero angle reference points. In different position of the axial direction of the rotor, set zero angle reference point F5 and F6 respectively on 0 degree and 90 degree of the periphery on the rotor.

Place the rotor R onto the balancing machine and set the angle sensor RF on the position Po3. In this position, the sensor RF can only detect the zero angle reference point F5. The unbalance of the rotor measured by the balancing machine is recorded as the first nominal unbalance.

Adjust the angle sensor RF on the balancing machine to the position Po4, in this position, the sensor can only detect the zero angle reference point F6. The measured unbalance of the rotor is recorded as the second nominal unbalance.

During two measurements, the amount and the direction of the balancing machine itself keep unchanged; the amount of the unbalance of the rotor has no change, but the direction is changed with 90 degree. According to the two measured unbalance and through vector calculation, the unbalance of the rotor is obtained.

There is no special requirement for the position of the above mentioned two zero angle reference points, as long as F5 and F6 deviate for a certain degree and the angle sensor only detects one reference point at each position. Optimal selection is different position in axial direction.

More zero angle reference points can be set on the rotor, every two points should deviate for a certain degree and the angle sensor only detects one reference point at each position. Optimal selection is every two points deviate for a certain distance in axial direction.

When move angle sensor from one position to a new position to detect a new zero-angle reference point, the position of the angle sensor should be set up so that the angle between two perpendicular lines as following is zero when view the two lines along the rotational axis, the two perpendicular lines are, the perpendicular line drawn from the point where the space position of new zero angle reference point is being detected by the angle sensor to the rotating axis of the rotor, and the perpendicular line drawn from the point where the space position of previous zero angle reference point is being detected by the angle sensor to the rotating axis of the rotor. A simple method is that moving the angle sensor along a fixed line parallel with the axis of the rotor, as shown in FIG. 6

Select two reference points arbitrarily, measure the unbalance of the rotor respectively by balancing machine, the unbalance of the rotor is obtained through vector calculation.

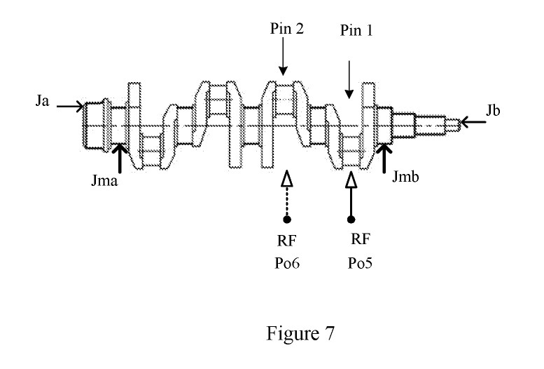

G. FIG. 7 shows a four cylinder engine crankshaft of passenger vehicle. When make the unbalance measurement for the engine crankshaft, use different pin journal Pin1 and Pin2 (the outermost point in the radial direction of the pin journal) on the crankshaft as different zero angle reference points.

In the example of this implementation, during the first measurement, place the angle sensor on the position Po5 and use the pin journal Pin1 as reference point, measure the unbalance of the crankshaft rotor and record it as the first nominal unbalance.

Adjust the angle sensor RF on the balancing machine to the position Po6 and use the pin journal Pin2 as the reference point. Measure the unbalance of the crankshaft rotor again and record it as the second nominal unbalance. According to the measured unbalance in two measurements and through vector calculation, the unbalance of the crankshaft is obtained.

H. In the mechanical manufacturing industry, various kinds of the rotors need be balanced, if it can be found on the part to be balanced that more than one different position can be used as zero angle reference point, these points deviate for a certain degree and only one reference point can be detected when place the angle sensor at one position, the methods in this invention can be used for the measurement and the unbalance of the rotor is obtained through vector calculation. Optimal selection is that the points deviate for a certain distance in the radial direction or the axial direction of the rotor.

Above description illustrates the specified implementation of this invention, however this invention is not limited to above implementation. Based on the technical thoughts of this invention, the implementation of this invention can be in any form.

1. A method to acquire unbalance of a rotor, for decoupling the unbalance of the rotor and the unbalance of the balancing machine itself, the mentioned balancing machine adopts free angle drive type to measure the unbalance of the rotor, with the characteristics as reflected through the following procedures:
set at least two zero angle reference points of the unbalance on the rotor, on a plane perpendicular to a rotating axis of the rotor, there is an angle between lines connecting a projection of each reference point to the projection of the rotating axis;
measure the unbalance of the rotor in a sequence by using each reference point as an angle reference, during the procedure, when moving an angle sensor from one position to a new position to detect a new zero angle reference point, position of the angle sensor should be set up so that the angle between two perpendicular lines as following is zero when view two lines along rotational axis, the two perpendicular lines are, perpendicular line drawn from the point where a space position of new zero angle reference point is being detected by the angle sensor to the rotating axis of the rotor, and the perpendicular line drawn from the point where the space position of previous zero angle reference point is being detected by the angle sensor to the rotating axis of the rotor; and
through a vector calculation of the unbalance corresponding to two arbitrarily selected reference points, the unbalance of the rotor is obtained.

2. (canceled)

3. According to the method in claim 1, with a characteristics of two reference points are set on the rotor.

4. According to the method in claim 1, with the characteristics of:
the reference points are set in same plane perpendicular to the rotating axis, in this plane, distance from the reference points to the rotating axis is different.

5. According to the method in claim 1, with the characteristics of:
the reference points are set in different planes perpendicular to the rotating axis.

6. A kind of rotor, with the characteristics of:
set at least two zero angle reference points in a plane perpendicular to the rotating axis, on the plane perpendicular to the rotating axis of the rotor, there is an angle between the lines connecting the projection of each reference point to the projection of the rotating axis.

7. A kind of rotor according to claim 6, with the characteristics of:
the reference points are set in the same plane perpendicular to the rotating axis, in this plane, the distance between the reference points and the rotating axis is different.

8. A kind of rotor according to claim 6, with the characteristics of:
the reference points are set in the different plane perpendicular to the rotating axis.
